(19) United States
(12) Patent Application Publication
(10) Pub. No.: US 2008/0268009 A1
(43) Pub. Date: Oct. 30, 2008

(54) Scented, fragrant water treatment capsules with biomedicides

(76) Inventors: Alan Schuster, Apex, NC (US); Larry Ruizzo, Lakewood, NJ (US); Shawn Mikuski, Lakewood, NJ (US); Richard Holstein, Lakewood, NJ (US)

Correspondence Address: CLIFFORD G. FRAYNE, 136 DRUM POINT RD, SUITE 7A, BRICK, NJ, 08723, US

(21) Appl. No.: 11/789,628

(22) Filed: Apr. 26, 2007

(51) Int. Cl. C02F 1/00; A01N 25/32

(52) U.S. Cl. 424/406; 210/167.11

(57) ABSTRACT

The present invention relates to hot tubs and spas, and in particular to a dispensing unit that distributes a water soluble solution of a scented fragrance in combination with a biomedicide or enzyme to provide a time release aroma therapy experience for a hot tub or spa, the biomedicide in the form of an enzyme aiding in the dissipation of the scented fragrance to allow introduction of a different replacement scented fragrance.

### BACKGROUND OF THE INVENTION

1. Field of the Invention

The present invention relates to swimming pools and other pools of standing water, and in particular spas and hot tubs, and in particular to a dispensing unit that distributes a time release, scented fragrance with biomedicides.

2. Description of the Prior Art

This invention relates to water quality, and more particularly to methods and apparatus for feeding controlled amounts of chemical solutions into swimming pools, hot tubs, spas, cooling towers and other standing water ponds. In the instant matter chemical solution is a scented fragrance with biomedicides (enzymes).

In home swimming pools and in newly popular hot tubs, spas, and other water pools, it is almost always necessary to filter and recirculate the water and to add certain chemicals, such as organic flocculating agents, which greatly improved the effectiveness of the filters in removing impurities. Other additives may include clarifiers, anti-scaling agents, algaecides, metallic stain preventors, scum line eliminators, filter cleaners and degreasers alone or in combination, plus spring pool or spa opening chemicals and winter closing chemicals.

Still further, it is often times desirable to include fragrances and scents to hot tubs and spas to enhance the sensory experience and provide aroma therapy.

It has been discovered that many of the desired water treatment chemicals needed for relatively small swimming pools, hot tubs and spas, can be packaged and shipped in closed and sealed plastic spheres of handy size. In use, one or more holes are opened in the shell of the sphere and the sphere and chemical solution enclosed is dropped in the water system. It has further been discovered that the motion of the water and of the sphere in the water can produce the desired rate of chemical feeding. A dispensor of this type and suitable for dispensing Applicant's formulation is disclosed by Etani in U.S. Pat. Nos. 4,880,547; 4,530,120; 4,853,131; 4,775,485; 4,692,314; and 4,519,814, which is incorporated by reference.

In one embodiment, the capsule is used to add a chemical from the group consisting of flocculants, coagulants, microbiocides, chelating agents, defoamers, germicides, and evaporation retarders, to the water of a backyard swimming pool, hot tub or spa. Dropped into the skimmer basket the capsule introduces the chemical at a substantially constant rate proportional to the rate of flow. Although at any instant the dispensing rate from the capsule will depend upon the position of the apertures relative to the flow, the positioned effect is eliminated, on the average, because of the movement of the capsule. This type of chemical feeding provides a cleaner pool, hot tub or spa and a more economical method of introducing the chemicals into the pool.

The same dispenser may be used to provide a scent/fragrance, aromatherapy to enhance the experience. The present invention adapts the use of these sealed plastic capsules to include a scented fragrance in combination with a biomedicide in the form of an enzyme which allows for and contributes to the dissipation of the fragrance or scent, as well as the oily bathing residues that tend to accumulate therein, so as to allow for use of a different, replacement fragrance or scent.

### OBJECTS OF THE INVENTION

An object of the present invention is to provide for a novel delivery system for water treatment chemicals for swimming pools, hot tubs and spas, which includes a scented fragrance and biomedicide and/or enzyme.

Another object of the present invention is to provide for a novel delivery system in the form of a safe container for storage, shipment and introduction of water chemicals, including a scented fragrance in combination with a biomedicide or enzyme that is both simple and safe.

Another object of the present invention is to provide for a novel delivery system in the form of a safe container for storage, shipment and introduction of water chemicals, including a scented fragrance in combination with a biomedicide or enzyme that combines the scented fragrance with a biomedicide or enzyme which assists in dissipating the scented fragrance so that a different replacement fragrance may be introduced.

### SUMMARY OF THE INVENTION

The present invention relates to swimming pools and other pools of standing water, particularly spas and hot tubs, and in particular to a dispensing unit that distributes a scented fragrance and biomedicide.

### BRIEF DESCRIPTION OF THE DRAWINGS

These and other objects of the present invention will become apparent, particularly when taken in light of the following illustrations wherein:

FIG. 1 is a schematic diagram of a typical home swimming pool;

FIG. 2 is a cross section of the dispensing container;

FIG. 3 is an alternative construction of the dispensing container;

FIG. 4 is a second alternative construction of the dispensing container; and

FIG. 5 is a cutaway view of the dispensing container.

### DETAILED DESCRIPTION OF THE INVENTION

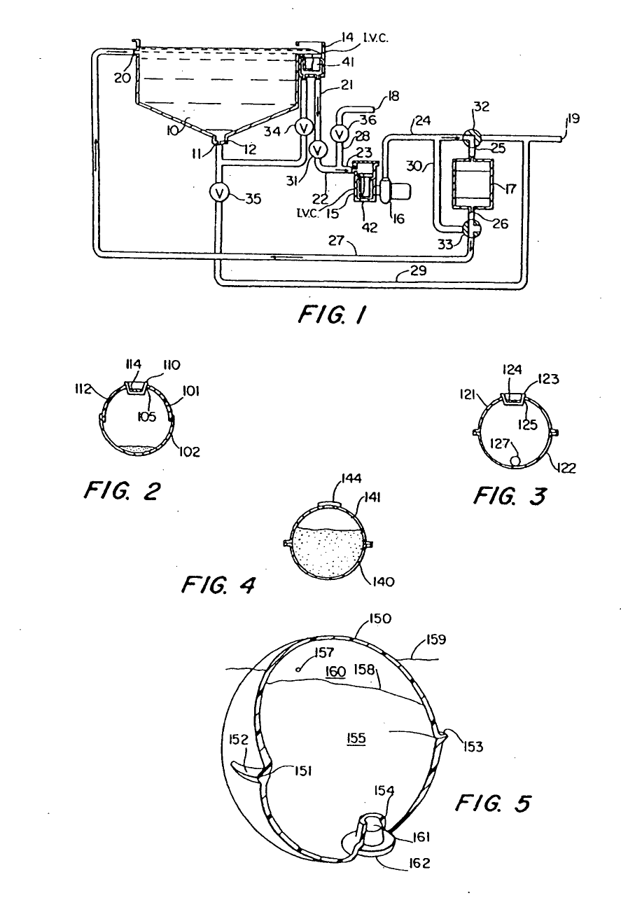

FIG. 1 illustrates a typical arrangement for a swimming pool or spa, the pool or spa comprises a pool 10, which has a drain 11 and sump 12 at the bottom of the pool, and a skimmer 14, which carries away overflow and collects floating debris, a strainer 15 at the inlet to a pump 16, a filter 17, a water main 18, a source of fresh water, a system outlet 19 and a pool inlet 20. Pipes 21-30 and valves 31-36 connect all of the aforesaid elements.

In normal operation water is taken from the pool through the skimmer 14, the pipe 21, the valve 31, pipes 22 and 23, strainer 15, pump 16, pipe 24, valve 32, pipe 25, filter 17, pipe 26, valve 33 and pipe 27, back to the pool inlet 20. Valve 34 allows water to be recirculated in whole or in part from the bottom drain 11 and valve 35 allows water to be gravity dumped through pipe 29 to the system outlet 19. Valve 36 connects the main 18 to replenish through pipes 28 and 23. The valves 32 and 33 may be turned to backwash the filter 17 via pipe 30. The skimmer 14 is arranged to collect leaves and other floating debris. To prevent the plugging of pipes 21, 22, 23, and pump 16, the skimmer 14 has perforated basket 41 of larger diameter and strainer 15 has a strainer basket 42. While the flow velocity of the baskets is much less than in the pipes, it is still perceptible and non-uniform so that when a container of chemical of the kind described hereafter is dropped into the perforated basket in the skimmer, or in the strainer basket, it bobs or flutters with the flow through the baskets. The feeder may be inserted at these places or a special chamber.

FIG. 2 is representative of a practical embodiment for a dispensing container for chemicals, hereinafter termed a “feeder” (the Etani patents). The feeder comprises two plastic hemispheres 101, 102 which are joined together in the manner of some table tennis balls with cement. The hemisphere 101 has a filling hole 105, which is closed by a plug 110. For dispensing the chemical, there are a number of small holes 112 in the hemisphere 101. Plug 110 has a porous buoyant portion 114.

FIG. 3 represents a construction in which two hemispheres 121 and 122 are joined at a flange. The thermo-plastic hemispheres with flanges can be made easily by the vacuum-forming process. This is the preferred construction when polyvinyl chloride (PVC) is used, or when the filling chemical is compressed into a solid ball “brickette”. The flange closure is readily achieved by ultrasonic welding, and the flange assists the rotation of the feeder in the eddies of flow. It also facilitates the handling and packaging of the feeders. The body of chemical, or an added weight 127 tends to stabilize the upward orientation of the feeder holes in conditions of low flow.

FIG. 4 represents an alternate closure of the feeder of FIG. 3. In this construction the feeder is filled by the supplier with a desired quantity of chemical 140, leaving an empty space 141, and sealed with a patch 144. The empty space may be filled with inert gas for chemicals which may be degraded in the presence of air or moisture. With this construction, the user must make the proper number of dispensing holes by piercing the feeder with a needle or the like.

FIG. 5 is a cut-away drawing of the capsule configuration preferred for most swimming pool and spa uses. The sphere is blow molded of high density polyethylene. The mold is made in two parts. When molding is complete the sphere is left with a small hole at 151 and a pair of stub wings 152 and 153 which serve the function of the flange in the configuration of FIG. 3. In preparation for filling, the blow hole 151 is closed, and the filling hole 154, formed in the mold, is cleanly cut through, both operations using an ultrasonic tool. It is desired that this capsule float with each dispensing hole 157 near the liquid levels inside 158, and outside 159, the capsule when it is resting in still water. To achieve this result, an air space 160 is left after filling with the emulsion, and zero-gauge buck shot 161 is swaged into the filler plug 162.

With respect to the capsule previously described, and its use for aromatherapy in providing a scented fragrance to the pool or spa, the capsule would be spherical in shape in its preferred embodiment, having a diameter of approximately 1⅞ths inches. The capsule could be fabricated from a variety of materials, but high density polyethylene would be the preferred material.

The sides of the capsule would allow for approximately two ounces of solution to be contained therein, which would allow treatment of up to 500 gallons of spa water. If the user were to pierce only one of the release apertures on the capsule, the scented fragrance would last approximately 10 to 14 days in the water. If both apertures on the capsule were pierced, the scented fragrance would last approximately 5 to 10 days.

The capsule after having one or both of its apertures pierced can be placed in a floater on the surface of the spa, directly on the body of spa water, or in a skimmer cavity. The fragrance durations and strengths will vary depending upon the location of the capsule in the spa and the scented fragrance contained in the capsule. The rate of disbursement and strength of fragrance are more apparent if the capsule is placed in the skimmer cavity due to the increase in the amount of suction and flow and turbulence. The range of biomedicide or enzyme would range from 0.001% to 10.00% by weight percent.

The type of scent or fragrance contained in the capsule are myriad. The scents or fragrances can be of the fruit variety, the plant variety, or the garden variety. The scents or fragrances may be packaged as a single scent, or a combination of fragrances can be combined into a fragrance bouquet. Applicant has used scents either alone or in combination, which include cherry blossom, citrus, mango, vanilla creme, eucalyptus, gardenia, lavender, pina colada, spring mist, forest glen, pear delight, and tropical paradise.

The assortment of scented fragrances, in combination with the inclusion of biomedicide or enzyme technology in the form of biomedicides in a convenient, easy to use time release capsule, treats the spa user to an aromatherapy sensation, while at the same time preventing scum lines or oily bathing residues, eliminating odors, and enhancing sanitizer performance, while reducing filter cleaning.

The biomedicide or enzyme contributes to water quality but also aid in the dissipation of the particular scented fragrance so that a replacement capsule with a different scented fragrance may be introduced by the user.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

What is claimed:

1. A dispenser and solution for dispensing the solution into a hot tub or spa or to provide for an aroma therapy experience, the dispenser and solution comprising:
a dispensing container being generally spherical in shape, having a neutral buoyancy dependent upon water velocity flow causing said dispensing container to randomly move about freely and rotate, said dispensing container defining a chamber of sufficient size to accommodate a solution to be time dispensed, said solution comprising a liquid scented fragrance in combination with a biomedicide.

2. The dispenser and solution in accordance with claim 1 wherein said solution comprises a water soluble fruit scented fragrance.

3. The dispenser and solution in accordance with claim 1 wherein said solution comprises a water soluble garden scented fragrance.

4. The dispenser and solution in accordance with claim 1 wherein said solution comprises a water soluble plant scented fragrance.

5. The dispenser and solution in accordance with claim 1 wherein said solution comprises a combination of water soluble fruit, garden, and plant scented fragrance.

6. The dispenser and solution in accordance with claim 1 wherein said solution comprises a biomedicide in the form of an enzyme which aids in the dissipation of the scented fragrance in order to introduce a substitute and different scented fragrance, said biomedicide in the form of an enzyme being present in the range of from 0.001 to 10.00%.
